(19) United States
(12) Patent Application Publication
(10) Pub. No.: US 2011/0299975 A1
(43) Pub. Date: Dec. 8, 2011

(54) BRAKE SYSTEM FOR A WIND TURBINE

(75) Inventor: Georgios Pechlivanoglou, Berlin (DE)

(73) Assignee: SUZLON ENERGY GMBH, ROSTOCK (DE)

(21) Appl. No.: 13/201,568

(22) PCT Filed: Feb. 16, 2010
(86) PCT No.: PCT/EP10/00946

§ 371 Date: Aug. 15, 2011

(30) Foreign Application Priority Data
Feb. 16, 2009 (DE) 10 2009 009 017.7

(51) Int. Cl. F01D 15/12; F03D 11/00; F16H 57/08; F16D 55/02

(52) U.S. Cl. 415/123; 188/72.3; 475/331

(57) ABSTRACT

The invention relates to a brake system for a wind turbine having a machine house rotatably mounted in horizontal plane on a tower, at least one stop brake (60) for locking the machine house and an electrical azimuth drive (40), wherein the stop brake (60) is connected to the azimuth drive (40) via means (50) for transferring moments and/or forces and/or movements in such a way that it can be actuated by means of a torsional moment generated by the azimuth drive (40) in order to yaw the machine house and/or a force and/or movement generated for this reason.

### TECHNICAL FIELD

The invention relates to a brake device for a bearing for wind turbines, in particular relates to a brake device of wind turbines, in which the machine house is rotatably supported on a tower by means of sliding bearings.

### BACKGROUND

From the prior art, it is known that there are two main principles for bearing of the machine house of a wind turbine on its tower. The first principle is based on the machine house to be rotatably supported on the tower by means of a roller bearing. This kind of bearing allows a low-friction yawing of the machine house in the case of desired wind tracing of the rotor blades.

In order to keep the nacelle in place against an unwanted yawing in consequence of fluctuating wind flow conditions, systems with roller bearings usually have large ring-disc brakes and hydraulically actuated brake shoes. The efficiency of such facilities to prevent unwanted yawing is sufficient; the reliability of these systems is apart from the susceptibility of hydraulic systems to leakage- acceptable. However, the disadvantage of such systems rests especially with the relatively high producing costs for such large roller bearings and necessary brakes for this.

In comparison with this, a cost-efficient design of wind turbines can be achieved with the help of a sliding bearing, through which the machine house is rotatably supported on the tower. Also this “sliding bearings solution principles” is used by several wind turbine manufacturers.

However, in the case of wind turbines with sliding bearings it must be ensured that the friction of sliding bearings is not too low, because otherwise the unwanted yawing of the machine house may occur due to fluctuating wind flow conditions. For this reason, such sliding bearings for wind turbines usually have a plurality of sliding mechanisms, with the help of which the sliding friction can be adjusted so that the unwanted yawing of the machine house is prevented.

The sliding friction of the sliding bearing is large enough for designed size to prevent the unwanted yawing of the machine house itself under the influence of strong wind forces, on the other hand, the friction forces can not be greater than the rotational force or moment, which can be applied by the azimuth drive, as otherwise yawing of the machine house to trace the wind would simply be not possible.

The concept of wind turbines with sliding bearings is successful and in addition to the low producing cost, also results in a high reliability of such systems. Besides, the equipments with sliding bearings are protected from unwanted yawing of the machine house due to their passive braking effects even in case of malfunction, and therefore are protected from potential damages.

As described above, it is necessary that large-dimensioned and expensive azimuth drives must be used to realize yawing against sliding friction. In the present tribological system it can lead to a rapidly alternating reciprocating movement between static and sliding friction, the so-called stick-slip-effect, during yawing. In addition, the high sliding friction provokes rapid material fatigue and high wear. However, on the other hand, a lower sliding friction would accept the risk of an unwanted yawing.

### SUMMARY OF INVENTION

An object of the present invention is to take advantages of sliding bearings for nacelles of machine houses and to reduce the described disadvantages.

According to the invention, this object is solved by a brake system for an azimuth bearing of a wind turbine, preferably for a wind turbine with sliding bearing, wherein the machine house supported on a tower in a manner of being rotatable in horizontal plane is initially locked and/or braked with a stop brake in the case of operation. Hereby, the stop brake is connected to an electric azimuth drive by means to transfer moments and/or forces and/or movements. In this way, the stop brake is able to be actuated by means of torsional moment generated by azimuth drive for the yawing of the machine house and/or via a force generated by the azimuth drive and/or via a movement generated by the azimuth drive.

Preferably, a lever is used as means for transferring, but other transmission means for moments, forces and movements in the form of shafts, gears, screws, hydraulic or pneumatic pressure lines, etc. are also seen as part of the invention.

Preferably, in addition to the stop brake, the azimuth drive is also connected to the azimuth transmission. Azimuth drive, stop brake and azimuth transmission hereby are arranged on the nacelle or on the tower, and are designed in such a way that a torsional moment and/or force and/or movement, if necessary, generated for the yawing of the machine house is transferred onto the stop brake to release it and is transferred to the azimuth transmission for the desired yawing of the machine house only when the stop brake is released.

Preferably, here the housing of the azimuth drive is connected to the machine house, while the azimuth transmission preferably formed as slew ring is firmly connected to the tower of wind turbine. Another embodiment of the invention also relates to a brake system for a wind turbine, wherein the azimuth transmission is connected to the machine house, and the azimuth drive is connected to the tower of the facility.

According to a particularly preferred embodiment, the housing of the azimuth drive is connected to the machine house, being supported in the rotation plane of its planetary gear set. Because of the high frictional resistance of the machine house on the tower, the bearing of the azimuth drive causes that the torsional moment generated for the yawing of the machine house leads initially not to yaw of the nacelle, but to a rotation of the azimuth drive around itself in the rotation plane of its planetary gear set.

According to a further embodiment, if the housing is connected to the stop brake of the machine house via a lever, then according to the invention the torsional moment generated by azimuth drive is initially transferred to the stop brake to release it. According to a further embodiment of the invention, the azimuth drive is supported to be rotatable only through a predetermined angle in positive and negative direction of rotation (namely, counterclockwise or clockwise) relative to the machine house. This causes that the azimuth drive does not rotate around itself any more after reaching the maximal rotation angle, and therefore its torsional moment is transferred via its driven wheel for yawing the machine house to the slew ring of the azimuth transmission.

According to a further embodiment, the housing of the azimuth drive is firmly, rather than rotatably, connected to the machine house. In order to implement an inventive brake system, in this case an independently inventive azimuth drive is used. According to a particularly preferred embodiment, such an azimuth drive has a housing, in which the ring gear of the planetary gear set is supported to be rotatable in the rotation plane of the planetary gear set. Such a bearing of the ring gear causes that the torsional moment generated for yawing of the machine house leads initially not to the yawing of the nacelle, but to a rotation of the ring gear of the planetary gear set around itself. According to the invention, this rotation of the ring gear is used to release the stop brake of the machine house similarly to the above described manner.

Preferably, the ring gear of the planetary gear set is therefore connected to the stop brake via a lever in such a way that the lever transfers the force produced by the rotation of the ring gear to release the stop brake.

In addition to a simple lever, according to further variations, there are also provided hydraulic or pneumatic mechanisms, wherein for all variations inheres the principle to use the rotational force of the ring gear of the planetary gear set or as previously described, of the rotating housing of the planetary gear set, in order to release one or several stop brakes of the machine house.

In order to cause a yaw of the machine house after the releasing of the stop brake(s), the rotation of the azimuth drive or the ring gear of the planetary gear set must be limited to a predetermined maximal rotation angle so that the azimuth drive is blocked when reaching this maximal rotation angle in its rotation, and the torsional moment/force/movement generated for yawing of the machine house is transferred to the slew ring of the azimuth transmission.

According to a particularly simple embodiment of the invention, the bearing of the housing of the azimuth drive or the bearing of the ring gear of the planetary gear set has a mechanical stopper, which predetermines the maximal rotation angle in positive and negative direction of rotation. If the housing of the azimuth drive is supported, then the mechanical stopper is preferably connected to the machine house. If the ring gear of the planetary gear set is rotatably supported, the mechanical stopper is preferably connected to the housing of the azimuth drive. The mechanical stopper is formed by the lever, which is connected to the stop brake, according to a further embodiment.

According to a particularly preferred embodiment, a rotation of the housing of the azimuth drive or of the ring gear of the planetary gear set is blocked by means of a passively actuated, active brake when the maximal rotation angle is reached. According to a particularly preferred embodiment of the invention, a hydraulic loaded brake is provided to block the rotation when a maximal rotation angle is reached. Such a passively actuated, active brake is preferably triggered by a sensor, which transmits to the active brake a braking signal for blocking the housing of the azimuth drive or of the gear ring of the planetary gear set.

According to a further preferred embodiment, the ring gear of the planetary gear set supported in the housing of the azimuth drive is damped via a passive hydraulic clutch arranged between gear ring and housing. In the case of an azimuth drive damped by means of a hydraulic clutch, a mechanical stopper is preferably used to limit the maximal rotation angle; particularly preferably, the lever connected to the stop brake is used as mechanical stopper.

A further independently inventive aspect of the brake system relates to the stop brake(s) of the machine house. In order to be safe even in case of incidents, the stop brake is preferably designed in such a way that it is automatically active, which means that it is activated without any external influence and the machine house is protected against an unwanted yaw. Preferably, the stop brake has at least one friction lining, a pressing stamp and a restoring spring, wherein the stop brake causes a locking of the nacelle by the restoring force of the restoring spring in installed state. Particularly preferably, the pressing plunger is directly or indirectly connected to the azimuth drive in installed state of the stop brake through a lever or other transmission device, such as a pressure line. By the force transmission via the lever or the force transmission device is the locking of the machine house released against the restoring force of the restoring spring. Particularly preferred is the stop brake designed in such a way that instead of the usual sliding mechanisms of sliding bearings it can be inserted into the recesses provided for it in a ring flange. In this way, the stop brakes can be retrofitted for existing wind turbines.

Preferably, the stop brake has a damping. Damping is especially advantageous if the lever for releasing the stop brake is used as mechanical stopper of the azimuth drive. Damping of the stop brake is generally useful to avoid a stick-slip-effect when releasing the stop brake and the machine house beginning to yaw.

Basically, the principle for releasing the stop brake(s) by means of the rotational force of the azimuth drive can not only be used for the sliding or roller bearing of a MACHINE HOUSE, but the same principle can also be used in the pitch system of the rotor blades, i.e. the rotation of the rotor blades around their longitudinal axis and provides a further inventive aspect of the application.

Such a brake system for a pitch bearing of a wind turbine hereby comprises at least one pitch drive and a stop brake for locking and/or braking of the pitch bearing. Here, the stop brake is connected to a pitch drive via means for transferring moments and/or forces and/or movements. In this way, the stop brake can be actuated by means of a torsional moment generated by pitch drive to adjust (pitch) the rotor blades and/or a force generated by the pitch drive and/or a movement generated by the pitch drive.

Preferably, a lever is used as means for transferring, but other transmission means for moments, forces or movements in the form of shafts, gears, screws, hydraulic or pneumatic pressure lines, etc. can be seen as part of the invention.

Preferably, in addition to the stop brake, the pitch drive is also connected to a pitch transmission. Pitch drive, stop brake and pitch transmission here are arranged on the rotor blade or hub, and designed in such a way that, if necessary, a moment and/or force and/or movement generated for pitching the rotor blades is initially transferred to the stop brake to release them, and then is transferred to the pitch transmission for pitching the rotor blades as desired only when the stop brake is released.

Preferably, the pitch drive is firmly connected to the hub and the pitch transmission in the form of a slew ring is firmly connected to a rotor blade.

According to a further embodiment, the pitch drive is connected to the hub in such a way that it is supported in a manner of being rotatable in the rotation plane of its planetary gear set.

According to a further embodiment, however, the housing of the pitch drive is not rotatably connected to the hub. In order to implement the inventive brake system, in this case an independently inventive pitch drive is used. Because in principle azimuth drive and pitch drive are built in the same way, the previously described variations of the azimuth drives correspond to the different variations for pitch drives.

Likewise, according to further embodiments are provided stop brakes, which are designed for installation in pitch systems according to the prior art. The variations of the stop brake for pitch systems correspond to the variations of the stop brake for azimuth bearings.

### BRIEF DESCRIPTION OF THE DRAWINGS

These and further aspects of the present invention will now be described in detail according to the following descriptions of drawings. It shows:

FIG. 1 a perspective view of a ring flange for a wind turbine with inserted sliding mechanism of a sliding bearing,

FIG. 2 a cross-sectional view of a sliding mechanism in installed state,

FIG. 3 a cross-sectional view of a first embodiment of a stop brake and a first embodiment of an azimuth drive or pitch drive in installed state,

FIG. 4 a), b) a cross-sectional view and a side perspective view of a second embodiment of the stop brake,

FIG. 5 a plan view as a schematic diagram of the force transmission of the rotational force of the azimuth or pitch drive to the stop brake according to FIG. 4,

FIG. 6 a), b) two cross-sectional views of a stop brake according to a third embodiment in an open and closed position,

FIG. 7a), b) two cross-sectional views of a stop brake according to a forth embodiment in an open and closed position,

FIG. 8 a) a cross-sectional view of an azimuth or pitch drive according to the prior art,

FIG. 8 b) a cross-sectional view of an azimuth or pitch drive with rotatably supported ring gear of its planetary gear set and hydraulic clutch,

FIG. 8 c) a cross-sectional view of an azimuth or pitch drive with rotatably supported ring gear of its planet gear set and active disc brake, and

FIG. 9 an overview of a sequence of steps of an operating method of the brake system during yawing.

### PREFERRED EMBODIMENTS

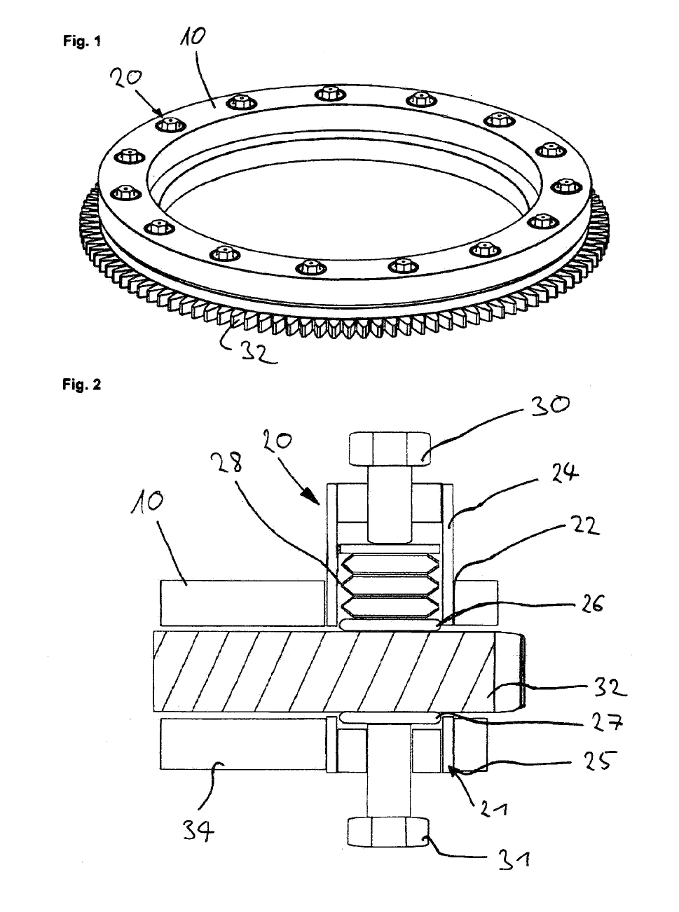

FIG. 1 shows an ring flange 10 for a wind turbine, which is connected firmly with the machine house of a wind turbine (or with the hub in a brake system for the pitch bearing) in conventional manner in installed state and rests on a slew ring 32. The slew ring 32 here is firmly connected to a tower of a wind turbine (or with a rotor blade in a brake system for a pitch bearing) in conventional manner in installed state. Cylindrical sliding mechanisms 20 are inserted in recesses or bores 22 radially arranged on the ring flange 10.

FIG. 2 shows the mode of action of a sliding mechanism 20, which is inserted in the ring flange 10 according to FIG. 1 and by means of which the sliding friction of the sliding bearing of the wind turbine is adjustable. The sliding mechanism 20 shown here comprises a cylindrical housing 24, a friction lining 26 arranged in the cylindrical housing 24, several disk springs 28 and an adjustment screw 30. Depending on how far the adjustment screw 30 is immersed in the housing 24 of the sliding mechanism 20, the pressure applied by the adjustment screw 30 on the disk spring 28 then become greater. By means of the adjustment screw 30, the contact pressure of the friction lining 26 on the slew ring 32 is indirectly increased. As a result, the sliding friction of the sliding bearing is increased as a whole.

Beneath the slew ring 32, a cover plate 34 is arranged, in which a sliding mechanism 21 is also inserted. This sliding mechanism 21 also has a cylindrical housing 25, in which a friction lining 27 and an adjustment screw 31 are arranged. The sliding mechanism 21 arranged under the slew ring 32 is used only to produce a defined sliding surface of the sliding bearing, while the sliding device 20 arranged on the top side can be used additionally to set a desired sliding friction.

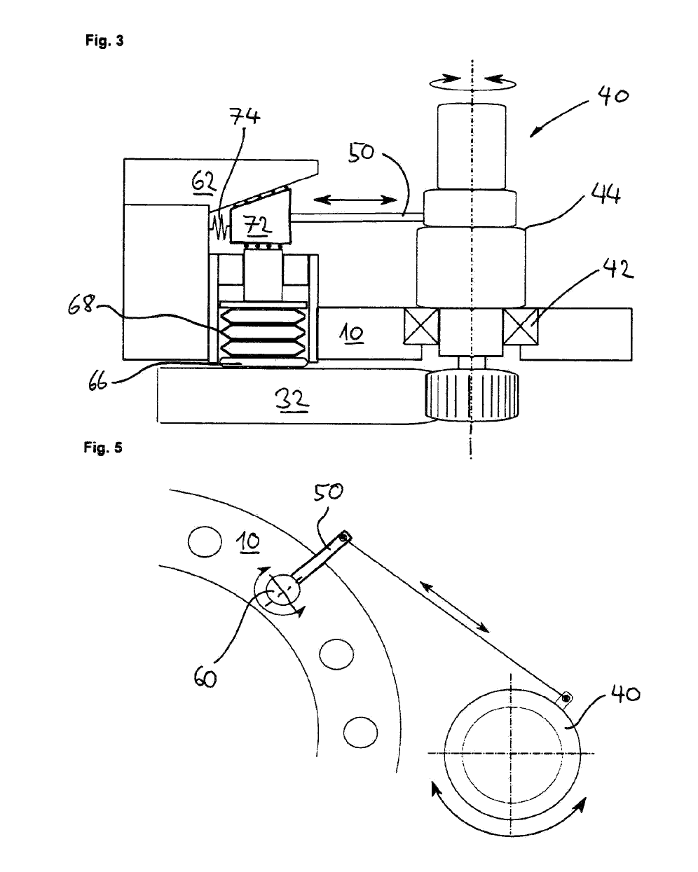

FIG. 3 shows a schematic diagram in cross-sectional view, which describes the operating principle between the azimuth drive 40, a first embodiment of a stop brake 60 and an azimuth transmission in the form of a slew ring 32 in more detail. In the ring flange 10 a stop brake 60 according to the first variation is inserted in place of a sliding mechanism 20. This variation of a stop brake 60 has, like the sliding mechanism 20 according to FIG. 2, a cylindrical housing 64, in which a friction lining 66 and several disk springs 68 are arranged. Instead of the adjustment screw 30, a pressing pin 70, which is used to apply a pressure on the disk springs 68 and thus indirectly generate a contact pressure of the friction lining 66 on the slew ring 32, is provided in the stop brake 60.

Between the upper surface of the pressing pin 70 and beneath a wedge-shaped cover plate 62 with tilting extending bottom surface there is a wedge element 72 with tilting extending upper surface. Bottom surface of the cover plate 62 and upper surface of the wedge element 72 are parallel to each other. Here, the wedge element 72 is supported between the bottom surface of the cover plate 62 and the upper surface of the pressing pin 70 in a rolling manner and secured between pressing pin 70 and cover plate 62 against slipping out by means of a restoring spring 74 arranged on its tip end. Here the restoring force of restoring spring 74 causes indirectly a contact pressure of the friction lining 68 on the slew ring 32.

If now a signal is issued to the azimuth drive (or pitch drive) 40 for yawing of the machine house (or for pitching of the rotor blades), then a torsional moment will be generated by the motor of the azimuth drive (or pitch drive). Because of the sliding bearing blocked by the stop brake 60, no yawing of the machine house (or pitching of the rotor blades), but a rotation of the azimuth drive (or pitch drive) 40 in its bearing 42 is caused by the torsional moment of the azimuth drive (or pitch drive) 40 at first. With a lever 50 arranged on the housing 44 of the azimuth drive 40, the rotational force of the azimuth drive (or pitch drive) 40 is transferred to the wedge element 72 of the stop brake 60, which is pulled out against the spring force of the restoring spring 74 between the cover plate 62 and the pressing pin 70. By pulling the wedge element 72 out, the pressing pin 70 is pressed upwards under the relaxation of the disk spring 68, whereby the pressing force of the friction lining 66 against the slew ring 32 decreases and the sliding bearing for yawing of the machine house in horizontal plane (or pitching of a rotor blade) is released. At the same time, the rotation of the housing 44 of the azimuth drive (or pitch drive) 40 arrives at a maximal rotation angle; a further rotation of the azimuth drive (or the pitch drive) (40) in the bearing 42 is blocked by a mechanical stopper (not shown here). Instead of using a sliding wedge 72, an equivalently acting lever can also come to use.

If now a further rotation of the azimuth drive (or pitch drive) 40 is not possible, then the torsional moment generated by the motor of the azimuth drive (or pitch drive) 40 is transferred onto the slew ring 32 and a yawing of the machine house (or a pitching of the rotor blade) is caused. The slew ring 32 hereby is preferably firmly connected to the tower and the azimuth drive 40 is preferably connected to the machine house via the bearing 42.

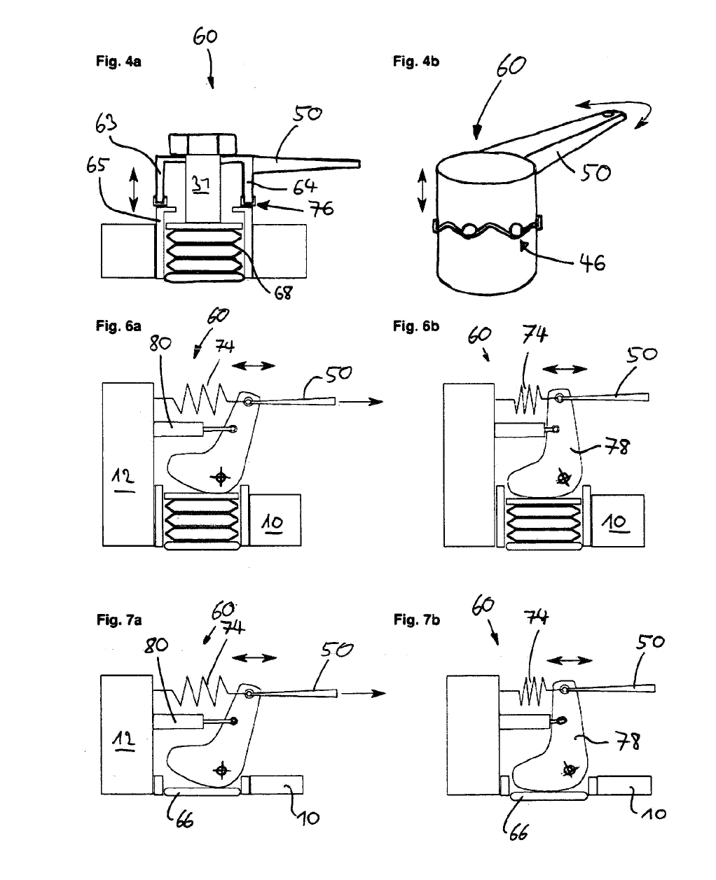

FIGS. 4a) and 4b) show the stop brake 60 of the brake system according to a second embodiment. This embodiment also has a cylindrical housing 64, in which a friction lining 66 and several disk spring 68 are arranged. Similar to the condition in the sliding friction mechanism 20 according to FIG. 2, an adjustment screw is arranged above the disk spring as a pressing pin to apply a contact pressure. Unlike the sliding mechanism 20, however, the housing 64 of this stop brake 60 is designed as two parts and consists of two cylindrical housing halves 63, 65, which are arranged vertically one above the other. Hereby, the housing halves 63, 65 are connected to each other via a bearing 76, in such a way that they are coaxially rotatable against one another along their longitudinal axes. However, as can be well seen in FIG. 4 b), the bearing 76 of this embodiment describes, as observed from a side view, a non-straight line, the terminal edges of the opposing housing halves 63, 65 are rather formed in sinusoidal form. If the upper housing half 63 of the stop brake 60 shown in FIG. 4 b) rotates relative to the lower housing half 65 by means of the lever 50, no matter whether the rotation takes place clockwise or counterclockwise, the upper half of the housing 63 will be lifted relative to the lower half 65. This would again cause that the adjustment screw 30, which is screwed into a thread 31 of the upper housing 63, would be lifted with the upper housing half 63, whereby the disk spring 68 would be relieved and thus the stop brake 60 would be released. This embodiment is particularly advantageous, since in this way the stop brake can be released regardless of the rotation direction of the yawing.

FIG. 5 is a top view of the variation shown in FIGS. 4 a) and 4 b). It can be seen particularly well from this view, how the stop brake 60 according to this embodiment can be inserted into a ring flange 10 of the prior art, instead of the sliding mechanisms 20. It can be seen well from this perspective, how the rotation of the azimuth drive (or pitch drive) 40 is transferred onto the lever 50 to release the stop brake 60.

FIGS. 6 a) and 6 b) show another variation of the stop brake 60 in a released 6 a) and in a firmly tightened position 6 b). According to this variation, the stop brake 60 of the brake system, like the previous variations, has a cylindrical housing 64, in which a friction lining 66 and several disk spring 68 are arranged. According to this variation, a bent braking lever 78, which operates as the pressing pin is used to apply the contact pressure. The braking lever 78 is hereby connected to a protrusion 12 of the ring flange 10 at one side by a restoring spring 74. With the restoring force of the restoring spring 74, the braking lever 78 is retracted and thus applies a force on the disk spring 68, which thus results in a contact pressure of the friction lining 66 against the slew ring 32 and thus results in a braking action of the stop brake 60. To release the stop brake 60, the braking lever 78 is connected or can be connected to the azimuth drive (or pitch drive) 40, which is not shown here, via another lever 50. Here, under working condition, the braking lever 78 is pulled to the right by the lever 50, which is connected to the azimuth drive (or pitch drive) 40, against the restoring force of the restoring spring 74 regardless of the rotation direction of yaw (see FIG. 6 b)). In the position of the stop brake 60 shown in FIG. 6 b), the braking lever 78 presses less strongly onto the disk spring 68, whereby they can extend upwards and whereby the frictional effect of the friction lining 66 on the slew ring 32 is reduced.

To avoid the stick-slip-effect, i.e. the jerky gliding of the friction lining 66 on the slew ring 32 due to a rapid succession of static and sliding friction during the transition between releasing the stop brake 60 and yawing of the machine house (or pitching), this embodiment of the stop brake 60 has a damper 80 additionally. Here, the damper 80 is arranged under the restoring spring 74 and prevents a backward swing of the lever 78 caused by stick-slip-effects during the releasing process of the stop brake 60. Without this damper 80, during the releasing process of the stop brake 60 at the moment when the static friction of the machine house is overcome, the machine house begin to yaw and the force effect of the azimuth drive 40 on the braking lever 78 is reduced as its consequence, the stop brake 60 would be drawn slightly again by the restoring force of the restoring spring 74. The damper 80 prevents that a resonant oscillation develops from this stick-slip-effect, which would have negative consequences on the material. The use of such a damper is also certainly conceivable in other embodiments, especially FIGS. 3 and 4.

FIGS. 7 a) and 7 b) show another embodiment of the stop brake 60 for the inventive brake system in an open and a closed position. This embodiment differs from that embodiment illustrated in FIGS. 6 a) and 6 b) only in that here the braking lever 78 presses directly on the friction lining 66. According to other embodiments of the stop brake lever 60, a flexible rubber buffer can also be inserted between the braking lever 78 and the friction lining 66 or the friction lining 66 itself can be designed to be flexible on the top side (not shown here).

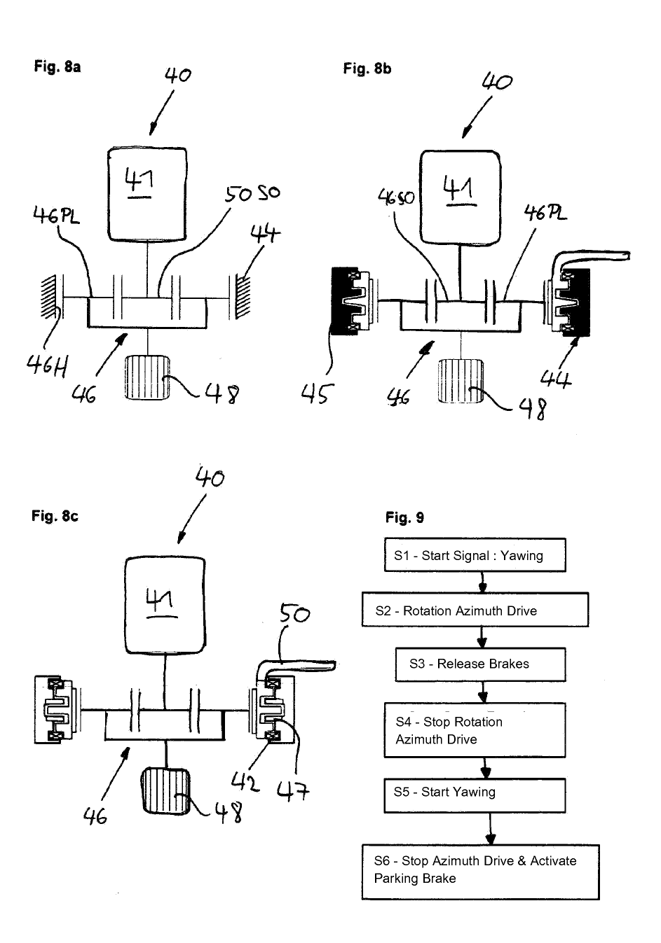

FIGS. 8 a), 8 b) and 8 c) show three different variations of the azimuth drive (or pitch drive) 40, how it can be used in the inventive brake system. While the embodiment of an azimuth drive (or pitch drive) 40 according to 8 a) is prior art itself, the variations according to 8 b) and 8 c) are an independently inventive aspect of the application.

The azimuth drive (or pitch drive) 40 according to 8 a) has a motor 41 for generating a torsional moment and a planetary gear set 46 arranged in the housing 44. The planetary gear set 46 has sun gear 46 SO, pinion gears 46 PL, ring gear 46 H and a carrier 46 ST on its part. A driven gear 48 is connected to the carrier 46 ST for transferring the torsional moment generated by motor 41 to the slew ring 32. The embodiment of an azimuth drive (or pitch drive) 40 shown here is the prior art and is characterized in that, the ring gear 46 H is firmly connected to the housing 44.

Azimuth drive (or pitch drive) 40 according to this embodiment must be connected to the machine house (or the hub) via bearing (not visible here) in order to make them suitable for the brake system according to this invention, so that they are rotatably supported relative to machine house with respect to the rotation axis of planetary gear set 46. Additionally, azimuth drives (or pitch drives) 40 according to this embodiment must be connected to a lever 50 on the housing 44, so that they are suitable for using in the brake system according to this invention.

The variation of the azimuth drive (or pitch drive) 40 shown in FIG. 8 b) corresponds to the embodiment according to FIG. 8 a) insofar that this drive has a motor 41, a planetary gear set 46 arranged in a housing 44 and a driven gear 48 connected to the carrier 46 S of the planetary gear set 46. Unlike the drive 40 of FIG. 8 a), the drive 40 according to FIG. 8 b) has a ring gear 46 H of the planetary gear set 46, which is supported in the housing of the azimuth drive (or pitch drive) 40 in such away that it can rotate in the rotation plane of the planetary gear set 46 by means of bearings 42. Here, the ring gear 46 H has a lever 50, which is used to make it possible to transmit a force onto the stop brake 60 in the installed state for its releasing. To limit the rotation of the ring gear 46 H to a maximal rotation angle, in this embodiment, the lever itself is used as a mechanical stopper. Additionally, the drive still has a hydraulic clutch 45, which acts as a damper to prevent a resonant vibration of the entire system due to stick-slip-effects and here slows down the rotation speed of the ring gear 46 H before reaching the mechanical stopper.

FIG. 8 c) shows a further variation of the azimuth drive (or pitch drive) 40 according to this invention. The drive 40 shown here has a motor 41, a planetary gear set 46 arranged in a housing 46, and a driven gear 48 connected to the carrier 46 S of the planetary gear set 46. As in the embodiment of FIG. 8 b), the ring gear 46 H of the planetary gear set 46 is supported in the housing 44 of the azimuth drive (or the pitch drive) 40 in such a way that it can rotate in the rotation plane of the planetary gear set 46 by means of bearings 42. However, the azimuth drive (or pitch drive) 40 here is equipped with a active brake 47 which can be passively activated, preferably a disc brake, which actively blocks the ring gear 46 H relative to the housing 44 when a maximal rotation angle is reached. Here, the signal for the active blocking of the brake 47 is passively controlled via the rotation angle of the azimuth drive (or pitch drive). The azimuth drive (or pitch drive) 40 has a sensor for example connected to the lever 50 (not shown here), which triggers a signal to the brake 47 for the blocking of the ring gear 46 H when a maximal rotation angle is reached. In the case of an active brake 47 for the blocking of the ring gear 46 H, no mechanical stopper for the azimuth drive (or pitch drive) 40 is required.

In FIG. 9 an overview is shown, which represents again a preferred sequence of steps, which is passed through by the brake system according to this invention during the yawing of the machine house. With a signal for the yawing of the machine house, the azimuth drive is activated S1. Since the housing is locked on the tower by the stop brake, a rotation of the azimuth drive is caused S2. The rotation of the azimuth drive causes the release of the stop brake S3. When a maximal rotation angle is reached, a stopper blocks the further rotation of the azimuth drive S4, whereby the force/moment of the azimuth drive is transferred onto the azimuth transmission and the yawing process begins S5. It can be seen in particular that at the end of the yawing process, as a final step S6, the housing 44 of the azimuth drive 40 or the ring gear 46 H of the planetary gear set 46 is returned to the initial position via the lever 50 by means of the restoring spring 74 of the stop brake 60. Simultaneously, the stop brake 60 is drawn again through the restoring spring 74.

1. Brake system for a wind turbine with a machine house supported on a tower in a manner of being rotatable in horizontal plane, wherein the brake system comprises at least one stop brake (60) for locking and/or for braking the machine house and an electric azimuth drive (40), characterized in that
the stop brake (60) is connected to the azimuth drive (40) via means (50) for transferring moments and/or forces and/or movements in such a way that
it can be actuated by means of a torsional moment generated by the azimuth drive (40) for yawing of the machine house and/or by means of a force and or movement generated for this purpose.

2. Brake system according to claim 1, wherein the azimuth drive (40) comprises an azimuth transmission (32), wherein azimuth drive (40), stop brake (60) and azimuth transmission (32) are arrange relative to each other and designed in such a way that a torsional moment generated by the azimuth drive (40) as needed for yawing of the machine house and/or a force and/or movement generated for this purpose is firstly transferred onto the stop brake (60) for its release and then is transferred to the azimuth transmission (32) for required yawing of the machine house only when the stop brake is released.

3. Brake system according to claim 1, wherein the azimuth drive in the form of a slew ring (32) is firmly connected to the tower and the azimuth drive (40) is connected to the machine house.

4. Brake system according to claim 1, wherein a housing (44) of the azimuth drive (40) or a ring gear (46H) of a planetary gear set (46) of the azimuth drive (40) is connected to the machine house in such a way that it is rotatably supported in the rotation plane of the planetary gear set (40).

5. Brake system according to claim 1, wherein the housing (44) of the azimuth drive (40) or the ring gear (46H) of the planetary gear set (46) is supported in such a way that it can only rotate by a predefined angle relative to the machine house in positive or negative rotation direction respectively.

6. Brake system according to claim 1, wherein a hydraulic clutch (45) is provided between the ring gear (46H) and the housing (44) for damping.

7. Brake system according to claim 1, wherein the housing (44) of the azimuth drive (40) or the ring gear (46H) of the planetary gear set (46) of the azimuth drive (40) has a lever (50) or can be connected to a lever (50), which causes a operation of the stop brake (60) of the machine house during a rotational movement of the housing (44) of the azimuth drive (40) or of the ring gear (46H).

8. Brake system according to claim 1, wherein a damper (80) is effectively provided between the stop brake (60) and the azimuth drive (40).

9. Azimuth drive (40) designed for a brake system according to claim 1, with a planetary gear set (46), wherein the ring gear (46H) of the planetary gear set (46) is supported in its housing (44) in such a way that it can rotate in the rotation plane of the planetary gear set (46).

10. Azimuth drive (40) according to claim 11, wherein the ring gear (46H) of the planetary gear set (46) can only be rotated by a predetermined maximal angle relative to the housing (44) in positive or negative rotation direction.

11. Azimuth drive (40) according to claim 11, wherein the ring gear (46H) of the planetary gear set (46) is damped relative to the housing (44) by means of a hydraulic clutch (45).

12. Azimuth drive (40) according to claim 11, wherein the ring gear (46H) of the planetary gear set (46) is locked relative to the housing (44)by means of a brake (47) to prevent a further rotation when a maximal rotation angle is reached.

13. Stop brake (60) for a machine house with at least one friction lining (66), a pressing stamp (30, 70, 78) and a restoring spring (74), wherein the stop brake (60) causes a locking and/or braking of the nacelle by means of the restoring force of the restoring spring (74) in installed state, and wherein a lever (50) directly or indirectly connected or connectable to the pressing stamp (30, 70, 78) reduces the restoring force of the restoring spring (74) during operation and thereby cancels the locking of the machine house, wherein the stop brake (60) is connected to the azimuth drive (40) by means (50) for transmitting moments and/or forces and/or movements, so that it is able to be operated by means of a torsional moment generated by the azimuth drive (40) for yawing of the machine house and/or a force and/or movement generated for this purpose.

14. Stop brake (60) according to claim 14, wherein the restoring effect of the restoring spring (74) is damped by means of a damper (80).

15. Wind turbine comprising a tower, a machine house, a rotor rotatably supported in the machine house, wherein the machine house is arranged to be rotatably supported basically vertically on the tower by means of an azimuth bearing, characterized by a brake system according to claim 1.
